(19) United States
(12) Patent Application Publication
(10) Pub. No.: US 2026/0238712 A1
(43) Pub. Date: Aug. 13, 2026

(54) MAGNETIC APPLICA FOR USE WITH CELLPHONES

(71) Applicant: LAUT DESIGN, LLC, Royce City, TX (US)

(72) Inventor: Christian MORGENSTERN, Royce City, TX (US)

(73) Assignee: LAUT DESIGN, LLC, Royce City, TX (US)

(21) Appl. No.: 19/537,362

(22) Filed: Feb. 11, 2026

Related U.S. Application Data
(60) Provisional application No. 63/757,270, filed on Feb. 11, 2025.

(51) Int. Cl. H04M 1/18; A45C 11/00; H01F 7/02; H04M 1/02

(52) U.S. Cl. CPC H04M 1/185; A45C 11/002; H01F 7/0252; H01F 7/0273; H04M 1/0202

(57) ABSTRACT

A system and method are disclosed for a decorative applique that couples to the back of a phone. The phone is configured to be charged by a coil in the back of the phone. The phone includes a permanent magnet to which the applique couples. The applique includes a layer of material having a first side and a second side. The first side of the layer has a decorative element. The second side of the layer contains, or is attached to, one or more magnets arranged to magnetically couple to the phone's permanent magnet.

### CROSS-REFERENCE FOR RELATED APPLICATIONS

This application claims priority benefit to US Provisional Application, Serial Number 63/757,270, filed February 11, 2025, by Christian Morgenstern, which is incorporated herein by reference in its entirety.

### BACKGROUND

### (1) Technical Field

This disclosure relates to design enhancements to cellular phones and more particularly to design features that can be placed on the case of a cellular phone.

### (2) Background

With the rapid development of mobile devices, it is getting increasingly common for people to desire design enhancements to make their mobile device more attractive, gain attention and to entertain people with such enhancements.

Cellular phones have become an integral part of modern life, influencing people of all ages, including children. The rapid advancement of mobile technology has made these devices more appealing and accessible than ever. For children, the attraction to cell phones is driven by various factors, including entertainment, communication, and social influence.

One of the biggest reasons children are drawn to cell phones is entertainment. Smartphones provide access to a wide range of games, videos, and interactive apps that keep children engaged for hours. Streaming platforms like YouTube and TikTok offer endless content tailored to their interests, making mobile phones a primary source of entertainment. Additionally, many educational apps provide interactive learning experiences, making phones an appealing tool for both fun and education.

Another major factor is communication. Many children use cell phones to stay connected with family and friends through text messages, voice calls, and social media. This constant connectivity gives them a sense of belonging and inclusion, which is particularly important in their developmental years. Social media platforms, in particular, create a digital space where children can interact, share experiences, and express themselves.

Peer influence also plays a crucial role in attracting children to mobile phones. When classmates and friends have smartphones, children often feel pressured to own one as well. The presence of mobile devices in social settings can make children feel left out if they don’t have one.

While parents and guardians need to monitor and set limits on phone usage to ensure children benefit from technology while avoiding its drawbacks, cell phones remain a must have for must young adults today.

Cell phones have become more than just communication devices; they are personal accessories that reflect individual style and personality. To make their phones stand out, many people use a variety of decorations to enhance their appearance. These decorations range from functional accessories to purely aesthetic embellishments, allowing users to personalize their devices in creative ways.

One of the most common decorative elements is the phone case. Available in countless designs, colors, and materials, phone cases not only protect the device but also serve as an extension of personal style. Some cases feature glitter, patterns, or custom prints, while others include 3D designs such as cartoon characters, animals, or luxury brand logos. There are even cases with built-in accessories like kickstands, wallets, or pop-out grips for better handling.

Phone charms and straps have also become popular decorative items. These small accessories, which attach to the phone or case, come in various forms, including beaded designs, plush figures, and even miniature versions of favorite characters. Many people use these charms to add a unique touch to their phones while also making them easier to hold or find in a bag.

Another way people enhance their phones is by applying stickers, skins, or decals. These can be used to cover the back of the phone or decorate the case with unique patterns, images, or text. Some opt for minimalist designs, while others go for bold and colorful looks.

For those who love a touch of glamour, rhinestones and custom embellishments can add sparkle and elegance. Do it yourself (DIY) enthusiasts even create custom decorations using paint, fabric, or other craft materials.

Ultimately, decorating a phone allows users to express their personality, keep up with trends, and make their device truly their own.

Accordingly, it would be advantageous to provide a device that can be easily attached to and removed from a cellular phone and that can enhance the appearance of and the functionality of a cellular phone.

### SUMMARY

In various embodiments, a magnetic applique (or “applica”) includes a decorative element. The magnetic applique may magnetically couple to a magnet mounted on a phone cover of a phone or to a circular magnet array in the back of the phone. In various embodiments, the magnetic applique includes a sheet of magnetic material that generally conforms to the shape of the applique and is applied to one side of the applique, which is the side that is opposite to the design. In some embodiments, the shape of the magnetic material conforms to the shape of a Mag-Safe magnet array in the case of a Mag-Safe compatible cell phone case onto which the applique may be placed (i.e., the magnet array). The placement and shape are chosen such that the magnetic applique adheres to the cell phone case in a detachable fashion. The strength of the magnetic sheet applied to the applique may be selected, such that the applique adheres firmly to a Mag-Safe compatible cell phone case, while still allowing the applique to be relatively easily removed. In various embodiments, the magnetic field (from the magnet array of the phone) within the phone is reduced by the sheet of magnetic material, when the applique is magnetically coupled to the back of the phone, via the magnet array. In some embodiments, the sheet of magnetic material is an array of one or more magnets. In some embodiments, the decorative element of the magnetic applique is a picture. In some embodiments, the decorative element is a pouch or wallet, which optionally includes a zipper for closing the pouch or wallet.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader’s understanding of the disclosed method and apparatus. They should not be considered to limit the breadth, scope, or applicability of the claimed invention. It should be noted that for clarity and ease of illustration these drawings are not necessarily made to scale.

FIG. 1A is an illustration of a prior art phone on which a magnetic decorative feature according to this specification can be attached.

FIG. 1B is an illustration of a prior art cover for the phone of FIG. 1A.

FIG. 2 is an illustration of one embodiment of a magnetic decorative feature in accordance with the disclosed device.

FIG. 3 is a side perspective view of the applique of FIG. 1.

FIG. 4 illustrates an applique magnetically fixed to a Mag-Safe® compatible cell phone case.

FIG. 5 illustrates the back side of the applique, which has an oval-shaped magnetic material that conforms to the shape of the magnet array of a Mag-Safe compatible phone case.

FIG. 6 is an illustration of a lion character applique.

FIG. 7 illustrates the back side of the applique with a magnetic material generally shaped to conform to the shape of the magnet array of a Mag-Safe cell phone case.

FIG. 8 illustrates the applique magnetically fixed to the cell phone in place of the applique.

FIGS. 9 and 10 illustration of one embodiment of a magmoji® wallet.

FIG. 11 is an illustration of another magmoji ® wallet magnetically secured to a phone.

FIG. 12 is an illustration of an embodiment of the alignment of the magnet array of the phone and the applique.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

Magnets are fascinating objects that produce a magnetic field, which attracts ferromagnetic and ferrimagnetic materials and weakly attracts paramagnetic materials. Magnets also weakly repel diamagnetic materials. Some ferromagnetic materials include iron, nickel, and cobalt. Hard magnets tend to retain their magnetization unless demagnetized, whereas soft magnets do not. Hard magnets may be referred to as permanent magnets. Electromagnets can be made by sending currents through a coil or a set of coils. The field strength of the electromagnet can be increased by placing a ferromagnet or ferrimagnet at the core of the coils. Two types of magnets include permanent magnets and electromagnets. When a hard magnetic material is magnetized, a permanent magnet is formed. Permanent magnets, such as bar magnets and sheet magnets, maintain their magnetism over time without the need for electricity. Magnets have played a crucial role in science, technology, and daily life for centuries. Magnets come in various shapes, sizes, and strengths, each designed for specific applications.

These are commonly used in household applications, from securing notes on refrigerators to being components in speakers and motors. Electromagnets, on the other hand, generate a magnetic field when an electric current passes through them. These are used in powerful applications like MRI machines, electric bells, and cranes that lift heavy metal objects in junkyards.

One of the fundamental properties of magnets is that they have two poles: north and south. Opposite poles attract, while like poles repel each other. This principle is the basis of many scientific and industrial applications, including compasses, which help in navigation by aligning with the Earth's magnetic field.

Magnets are also essential in modern technology. They are found in hard drives, electric generators, and even credit card strips. In medicine, magnets are used in MRI scans to produce detailed images of the human body.

Additionally, magnets are popular in toys, jewelry, and decorative items. Magnetic stickers and magnetic phone holders have become trendy accessories for convenience and style.

From everyday uses to advanced scientific applications, magnets continue to be an indispensable part of human life, showcasing the incredible power of unseen forces at work.

Magnets are increasingly being integrated into cell phone cases to enhance functionality and convenience. These magnetic phone cases serve multiple purposes, from improving grip and protection to enabling seamless attachment to cell phone mounts.

One of the uses of magnets in phone cases is for magnetic mounts. Many car mounts and stands rely on magnets to securely hold a phone in place while driving or working. These mounts typically consist of a magnetic plate inside the phone case that connects to a magnetic holder, allowing for hands-free use without the need for clamps or cradles. This feature is particularly useful for navigation, as it enables users to view their screens without holding their devices.

Magnets are also used with MagSafe® technology. MagSafe-compatible phone cases contain built-in magnets that align perfectly with wireless chargers, ensuring efficient and secure charging. This eliminates the hassle of plugging the phone into cables while charging the phone, and allows for faster, more convenient charging. Additionally, MagSafe-compatible cases support attachment to wallets, cardholders, and power banks, which can be easily snapped onto the back of the phone.

Magnets in phone cases are also used with stands for hands-free media viewing. Other uses include detachable wallet compartments or kickstands, making them versatile for everyday use.

While magnetic phone cases offer numerous benefits, some users worry that magnets might interfere with phone components. However, most modern magnets used in phone cases are designed to be safe and do not affect signals, sensors, or internal components.

Overall, magnets in phone cases can provide a combination of convenience, functionality, and style, making them a popular choice for modern smartphone users.

In some embodiments of the presently disclosed method and apparatus, magnetic material is added to the backing of a relatively soft decorative element to allow the decorative element to be magnetically coupled to the case of a cell phone.

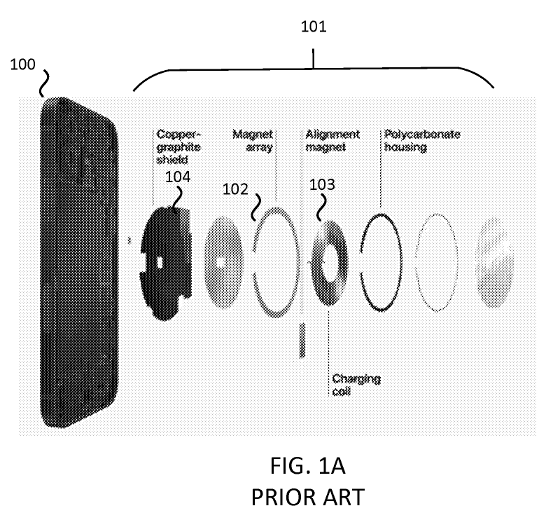

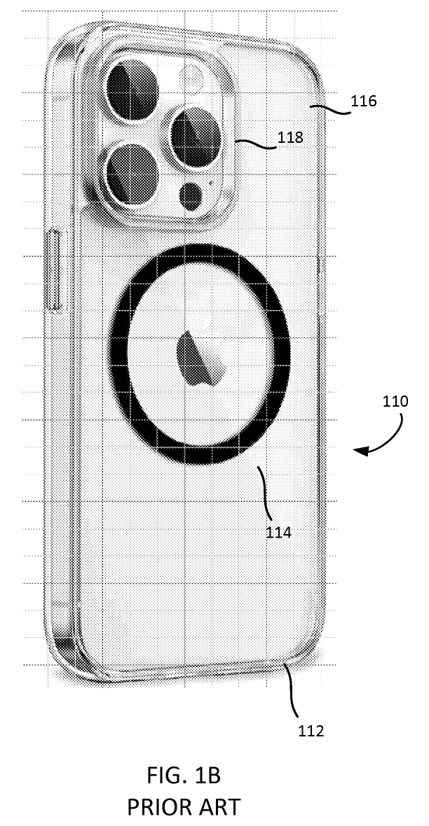

FIG. 1A is an illustration of a prior art phone 100 and the associated prior art components 101 within the phone 100 in accordance with a MagSafe charging system. A magnet array 102 is formed as a ring and placed in the rear of the phone adjacent to a charging coil 103 (among others of the MagSafe components 101). The magnet array 102 is designed to magnetically couple to a corresponding magnet array (not shown) within a MagSafe charger (not shown) to ensure that the charging coil within the phone is properly aligned with a corresponding charging coil within the MagSafe charger. The magnet array 102 may include one or more permanent magnets. The graphite shield 104 shields the circuitry of the phone 100 from the magnetic fields of the magnet array 102, charging coil 103 and external magnets, to at least some degree.

FIG. 1B illustrates a prior art phone cover 110. The phone cover 110 has a back 112, which optionally includes a location for mounting a magnet 114 (or a ferromagnetic or ferrimagnetic material that is not magnetized), outer rim 116 and camera border 118. The rim 116 forms a wall around the edges of the phone. The camera border 118 forms a wall surrounding the camera. The phone 100 may be placed in the phone cover 110 with the magnet array 102 adjacent to the location for mounting the magnet 114.

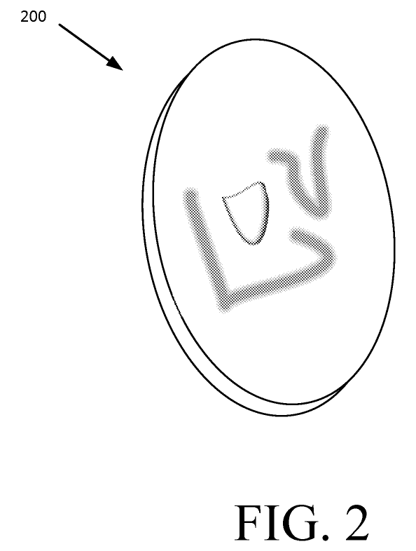

FIG. 2 is an illustration of one embodiment of such a decorative element in the form of a magnetic applique 200. Decorative writing or design patterns are visible from one side of the applique 200. In various embodiments, the applique 200 is circularly shaped. The magnetic applique 200 may magnetically couple to a magnet mounted on the phone cover 110 or magnetically couple to the magnet array 102 (with or without phone cover 110).

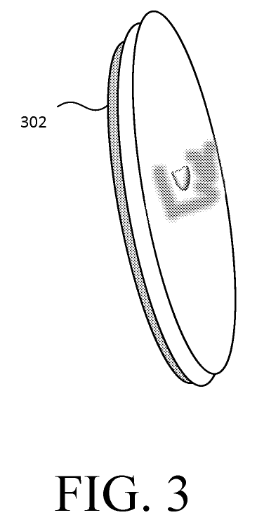

FIG. 3 is a side perspective view of the applique 200. A sheet of magnetic material 302 generally conforms to the shape of the applique, which is applied to the side of the applique 200 opposing the side having the design. In some embodiments, the magnetic material conforms to the shape of a Mag-Safe magnet array in the case of a Mag-Safe compatible cell phone case onto which the applique 200 may be placed. The placement and shape are chosen such that the appliqué 200 adheres to the cell phone case in a detachable fashion. The strength of the magnetic sheet applied to the applique 200 may be selected, such that the applique 200 adheres firmly to a Mag-Safe compatible cell phone case, while still allowing the applique 200 to be relatively easily removed. In some embodiments, the magnetic field (from the magnet array 102) within the phone is reduced by the sheet of magnetic material 302, when the applique 200 is magnetically coupled to the back of the phone 100, via the magnet array 102. In some embodiments, the sheet of magnetic material 302 is an array of one or more magnets. In some embodiments, the sheet of magnetic material 302 is flexible. In some embodiments, applique 200 is flexible.

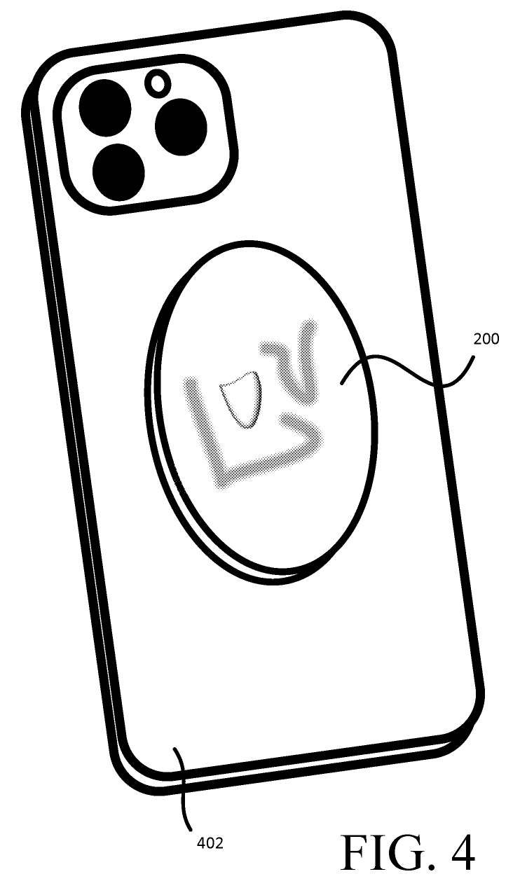

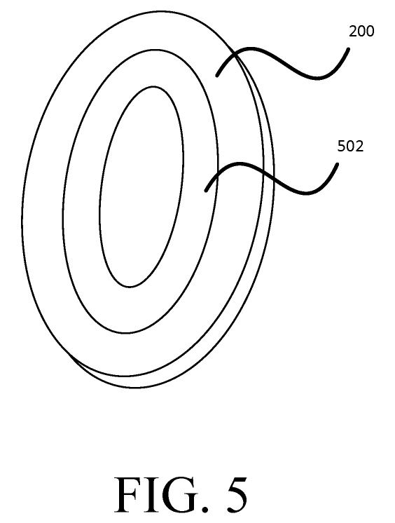

FIG. 4 illustrates an applique 200 magnetically fixed to a Mag-Safe compatible cell phone case 402. FIG. 5 illustrates the back side of the applique 200 having a generally oval-shaped (or circular) magnetic material 302 that conforms to the shape of the magnet array of a Mag-Safe compatible phone case 402, thus allowing the applique 200 to adhere to the cell phone case 402 magnetically. In various embodiments, the outer diameter of the sheet of magnetic material 302 is less than 3 inches. In various embodiments, the outer diameter of the sheet of magnetic material 302 is approximately 2.17 inches.

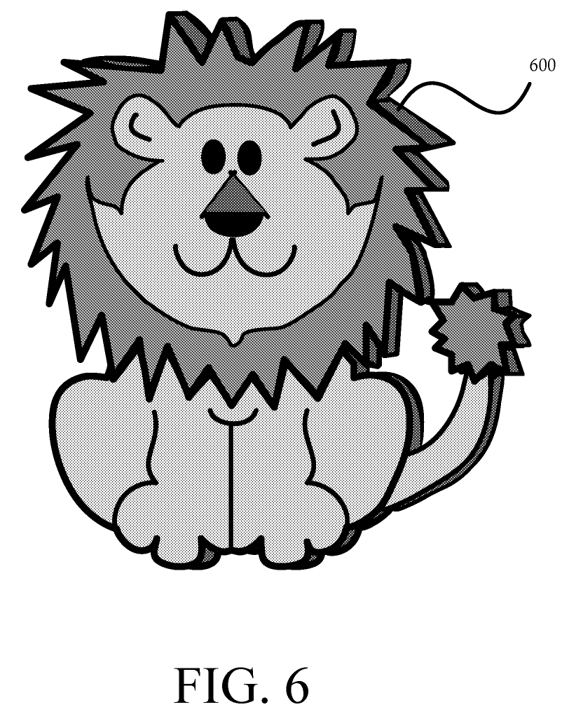

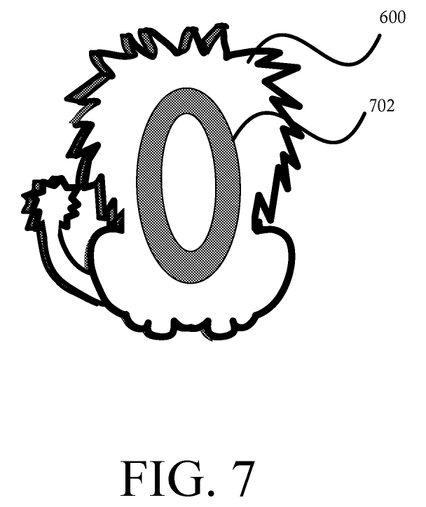

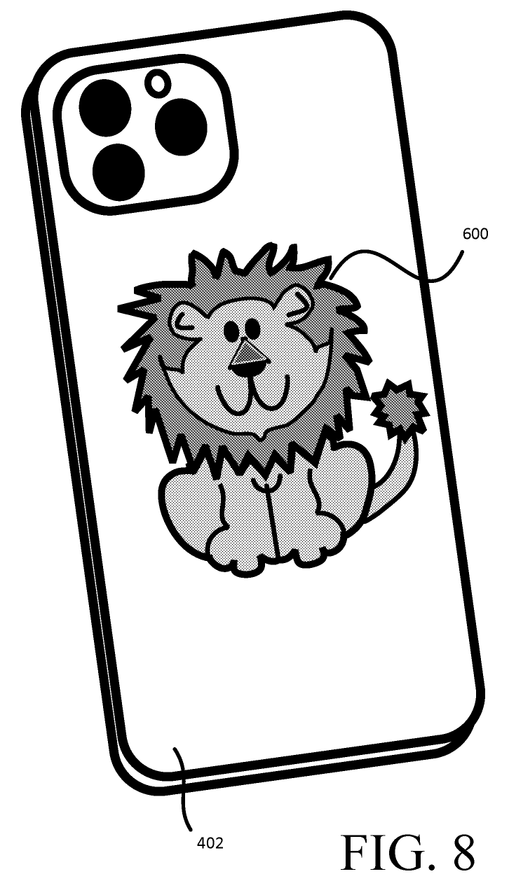

FIG. 6 is an illustration of a lion character applique 600. The lion character applique 600 is one example of a decorative applique that might be appealing to a young adult. FIG. 7 illustrates the back side of the applique 600 with a magnetic material 702 generally shaped to conform to the shape of the magnet array 102 of a Mag-Safe cell phone case 402. FIG. 8 illustrates the applique 600 magnetically fixed to the cell phone 402 in place of the applique 200.

In addition to decorative appliques, the presently disclosed method and apparatus includes embodiments in which a zippered wallet having a magnet array sewn into the wallet is configured to be magnetically coupled to a phone have a Mag-Safe compatible phone case, or other Mag-Safe element, such as having a Mag-Safe compatible magnet array configured directly within the cell phone.

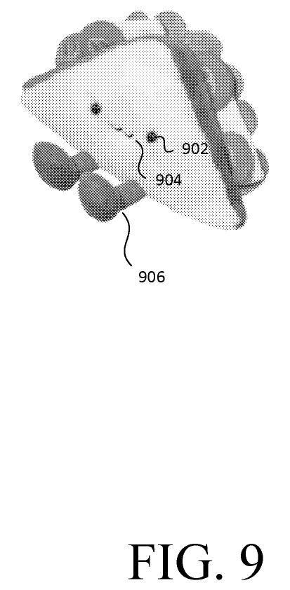

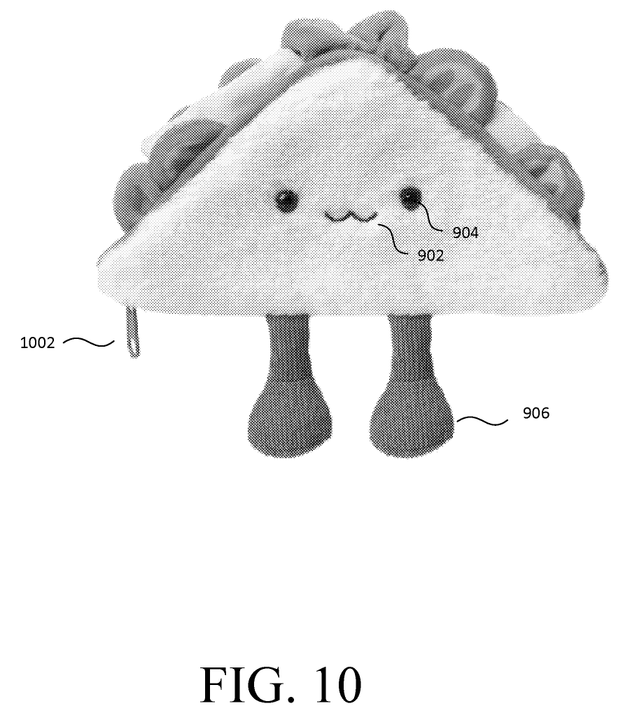

FIGS. 9 and 10 illustration of one embodiment of a magmoji® wallet 900. The wallet 900 is formed and decorated as a taco with a mouth 902, eyes 904 and legs 906. A zipper 1002 allows access to the interior of the wallet 900 and allows items placed within the wallet 900 to be secured by closing the zipper 1002.

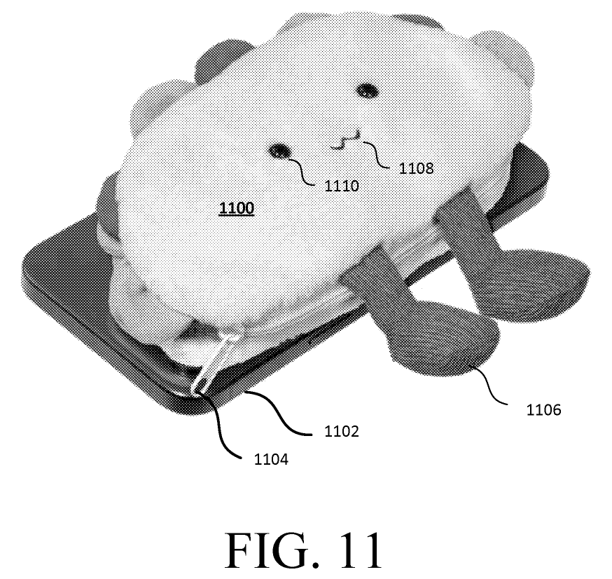

FIG. 11 is an illustration of another magmoji ® wallet 1100 magnetically secured to a phone 1102. Like the taco magmoji wallet 1100, the sandwich magmoji wallet 1100 has a zipper 1104, legs 1106, a mouth 1108 and eyes 1110.

In various embodiments, the applique 200 fits within the outer rim 116 of the phone coverage 110. In various embodiments, the applique 200 fits within the outer rim 116 of the phone coverage 110. In various embodiments, the applique 200 aligns with and has the same shape and size as the location outlined by the outer edge of the location for mounting a magnet 114.

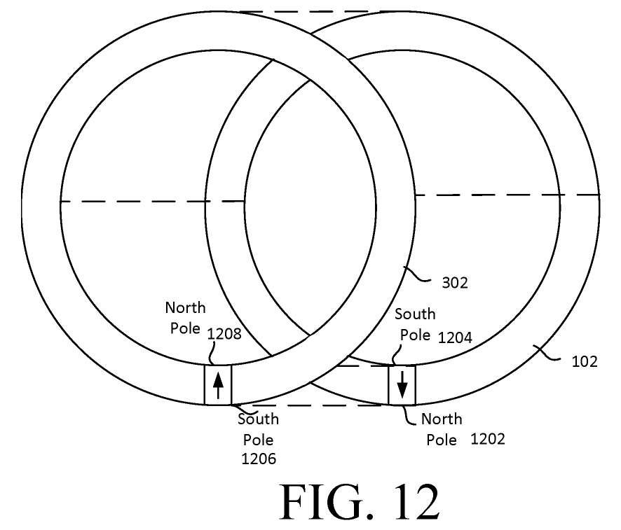

FIG. 12 is an illustration of an embodiment of how magnet array 302 may be arranged with respect to magnet array 102. Although in FIG. 12, magnet arrays 302 and 102 are displaced sideways from one another, that is only so that the alignment of their poles with one another can be seen more clearly. In some embodiments, the magnetization patterns of magnet array 302 and 102 are complementary to one another. The magnet array 102 may have one or more regions with North Poles 1202 and South Poles 1204 (the different regions may have different directions of magnetization). Similarly, the magnet array 302 may have one or more regions with North Poles 1206 and South Poles 1208 (the different regions may have different directions of magnetization). However, the magnet array 302 is positioned so that North Pole 1208 is closer to South Pole 1202 than North Pole 1204. Similarly, magnet array 302 is positioned so that South Pole 1206 is closer to North Pole 1204 than South Pole 1202. In various embodiments, magnet array 302 is aligned (and in registration) with magnet array 102. Similar is true of the other regions of the magnet array 102 and 302 that are opposite one another. Which magnetic pattern is placed on magnet array 102 or 302 does not matter, so long as the patterns are complementary to one another.

### Alternatives and Extensions

Although the specification discusses magnetically coupling the magnetic appliqué 200, via the permanent magnet 102, to phone 100 or phone cover 110, the phone 100 and phone cover 110 are just examples. The magnetic applique 100 can be attached to any device having a permanent magnet that couples to the magnet array 302. The pattern of North poles and South poles of the magnet array 302 can be chosen to couple with the pattern of North poles and South poles of a permanent magnet of any device.

The magnet array 102 could be located on either side of the charging coils 102 or in the phone cover 110, and the magnetic applique 200 would function the same. If the phone 100 does not have charging coils 103 or is intended to be removed from the phone cover 110 when charging, a carbon shield, like carbon shield 104 (in addition to magnetic array 102), can also be placed in phone cover 110, between phone 100 and the magnetic array 102, without affecting the operation of the magnetic applique 200.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed:

1. A system comprising:
a layer of material having a first side and a second side;
the first side of the layer having a decorative element; and
the second side of the layer having an array of one or more magnets arranged to magnetically couple to a circular array of one or more magnets.

2. The system of claim 1, wherein the layer of material is flexible.

3. The system of claim 1, wherein the array of one or more magnets has a diameter of less than 3 inches.

4. The system of claim 1, wherein the system forms an applique.

5. The system of claim 4, the layer of material being a first layer of the applique, the array of one or more magnets forming a second layer attached to the applique.

6. The system of claim 5, the array of one or more magnets being arranged in a circle conforming in shape to the circular array of one or more magnets to which the applique attaches.

7. The system of claim 5, the circular array of one or more magnets to which the applique couples being part of a cell phone and the array of one or more magnets on the second layer of the applique.

8. The system of claim 7, the array of one or more magnets conforms in shape to the applique.

9. The system of claim 8, the first layer being attached to a pouch.

10. The system of claim 9, the pouch having a zipper.

11. The system of claim 10, the pouch being a wallet.

12. A method for applying an applique, the applique including at least:
a layer of material having a first side and a second side;
the first side of the layer having a decorative element; and
the second side of the layer having an array of one or more magnets arranged to magnetically couple to a circular array of one or more magnets;
the method comprising placing applique on a back side of a phone, with the array of one or more magnets of the applique aligned with the circular array of one or more magnets of the phone.

13. The method of claim 12, wherein the material is flexible.

14. The method of claim 12, wherein the array of one or more magnets has a diameter of less than 3 inches.

15. The method of claim 1, the layer of material being a first layer of the applique, the array of one or more magnets forming a second layer attached to the applique.

16. The method of claim 15, the array of one or more magnets being arranged in a circle conforming in shape to the circular array to which the applique attaches.

17. The method of claim 16, the circular array of one or more magnets to which the applique couples being part of a cell phone and the array of the one or more magnets on the second layer of the applique.

18. The method of claim 17, the array of one or more magnets conforms in shape to the applique.

19. The method of claim 18, the first layer being attached to a pouch.
